(19) United States
(12) Patent Application Publication
(10) Pub. No.: US 2017/0116599 A1
(43) Pub. Date: Apr. 27, 2017

(54) METHOD FOR PREDICTING PURCHASING BEHAVIOUR OF DIGITAL WALLET USERS FOR WALLET-BASED TRANSACTIONS

(71) Applicant: MasterCard International Incorporated, Purchase, NY (US)

(72) Inventors: Sheetanshu Gupta, Jaipur (IN); Ashutosh Sharan, Gurgaon (IN); Mayank Prakash, Dehradun (IN)

(21) Appl. No.: 15/334,883

(22) Filed: Oct. 26, 2016

(30) Foreign Application Priority Data
Oct. 27, 2015 (SG) 10201508866S

(51) Int. Cl. G06Q 20/36; G06Q 20/34; G06Q 30/02; G06F 17/30

(52) U.S. Cl. CPC G06Q 20/363; G06F 17/30424; G06F 17/30377; G06F 17/30522; G06Q 20/341; G06Q 30/0201

(57) ABSTRACT

A computer-implemented method for predicting purchasing behaviour of digital wallet users for wallet-based transactions made by the digital wallet users is provided. The method includes identifying payment card users having a profile characteristic that matches the profile characteristic of the digital wallet users. The method also includes retrieving historical transaction data by querying a transaction database, wherein the historical transaction data relates to a plurality of historical transactions settled for the identified payment card users. The method further includes identifying, from the retrieved historical transaction data, transaction information of the identified payment card users to derive purchasing behaviour of the identified payment card users. The method also includes predicting the purchasing behaviour of the digital wallet users for wallet-based transactions made by the digital wallet users, based on the derived purchasing behaviour of the identified payment card users.

### CROSS REFERENCE TO RELATED APPLICATIONS

This application claims the benefit of Singapore Patent Application No. 10201508866S filed Oct. 27, 2015, which is hereby incorporated by reference in its entirety.

### BACKGROUND

The present disclosure relates broadly, but not exclusively, to methods for predicting purchasing behaviour of digital wallet users for wallet-based transactions, particularly digital wallet users satisfying a profile characteristic.

A digital wallet (which is also known as an e-wallet) is typically used to store various forms of electronic money to aid in completing e-commerce transactions (or wallet-based transactions). For example, it is possible to link/register a payment card to a digital wallet to perform a wallet-based transaction. Recently, a digital wallet may also be implemented on portable wireless client devices, such as a smart phone.

There are many different ways that one may adopt the use of a digital wallet. For example, Google Wallet® allows users to purchase goods and/or services by using a payment card that is registered on a smartphone or a tablet. However, Google Wallet® currently only supports about thirty merchants so the usage of Google Wallet® is rather limited. Another example, Apple's Passbook®, allows users to purchase goods and/or services by scanning 2D barcodes to manage the purchases and loyalty points. However, unlike Google Wallet®, Apple's Passbook® does not allow the users to directly register/use a payment card for purchasing goods and/or services. Instead, Apple's Passbook requires the users to download an additional app, BillGuard®, in order to manage the transactions. Hence, it can be seen that there are many different entities providing various ways of using a digital wallet. As such, it is difficult or impossible to analyse the historical financial behaviour of the digital wallet users for wallet-based transactions, particularly digital wallet users satisfying the specific profile characteristic, in order to accurately predict their future spending behaviour.

A need, therefore, exists to provide methods for predicting purchasing behaviour of digital wallet users in a group that addresses one or more of the above problems.

Furthermore, other desirable features and characteristics will become apparent from the subsequent detailed description and the appended claims, taken in conjunction with the accompanying drawings and this background of the disclosure.

### BRIEF DESCRIPTION

According to the first aspect of the present disclosure, a computer-implemented method for predicting purchasing behaviour of digital wallet users for wallet-based transactions made by the digital wallet users, the digital wallet users satisfying a profile characteristic, is provided. The method includes identifying payment card users having a profile characteristic that matches the profile characteristic of the digital wallet users, retrieving historical transaction data by querying a transaction database, the historical transaction data relating to a plurality of historical transactions settled for the identified payment card users, identifying, from the retrieved historical transaction data, transaction information of the identified payment card users to derive purchasing behaviour of the identified payment card users, and predicting the purchasing behaviour of the digital wallet users for the wallet-based transactions made by the digital wallet users, based on the derived purchasing behaviour of the identified payment card users.

According to the second aspect of the present disclosure, an apparatus for predicting purchasing behaviour of digital wallet users for wallet-based transactions made by the digital wallet users, the digital wallet users satisfying a profile characteristic, is provided.

The apparatus including at least one processor, and at least one memory including computer program code. The at least one memory and the computer program code configured to, with at least one processor, cause the apparatus at least to identify payment card users having a profile characteristic that matches the profile characteristic of the digital wallet users, retrieve historical transaction data by querying a transaction database, the historical transaction data relating to a plurality of historical transactions settled for payment card users, identify, from the retrieved historical transaction data, transaction information of the identified payment card users to derive purchasing behaviour of the identified payment card users; and predict the purchasing behaviour of the digital wallet users for wallet-based transactions made by the digital wallet users, based on the derived purchasing behaviour of the identified plurality of payment card users.

### BRIEF DESCRIPTION OF THE DRAWINGS

Embodiments of the disclosure will be better understood and readily apparent to one of ordinary skill in the art from the following written description, by way of example only, and in conjunction with the drawings, in which:

FIG. 1 shows a block diagram of a transaction system 100 within which transaction data can be received.

FIG. 2A and FIG. 2B show a flow chart illustrating a computer-implemented method for predicting purchasing behaviour of digital wallet users satisfying a profile characteristic according to an example embodiment.

FIG. 3 shows a schematic diagram of a computer system suitable for use in executing the method depicted in FIG. 2.

FIG. 4 shows an exemplary computing device to realize a server for the payment network server 108 shown in FIG. 1.

### DETAILED DESCRIPTION

Embodiments of the present disclosure will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic, or optical signals capable of being stored, transferred, combined, compared, and otherwise manipulated.

Unless specifically stated otherwise, and as apparent from the following, it will be appreciated that throughout the present specification, discussions utilizing terms, such as “scanning”, “calculating”, “determining”, “replacing”, “generating”, “initializing”, “outputting”, “receiving”, “retrieving”, “identifying”, “predicting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may include a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the disclosure.

Furthermore, one or more of the steps of the computer program may be performed in parallel rather than sequentially. Such a computer program may be stored on any computer readable medium. The computer readable medium may include storage devices, such as magnetic or optical disks, memory chips, or other storage devices suitable for interfacing with a computer. The computer readable medium may also include a hard-wired medium, such as exemplified in the Internet system, or wireless medium, such as exemplified in the GSM mobile telephone system. The computer program when loaded and executed on such a computer effectively results in an apparatus that implements the steps of the preferred method.

Various embodiments of the present disclosure relate to methods for predicting purchasing behaviour of digital wallet users for wallet-based transactions made by the digital wallet users, particularly, the digital wallet users satisfying a profile characteristic. In an embodiment, the method is a computer-implemented method which predicts purchasing behaviour of digital wallet users for wallet-based transactions made by the digital wallet users, particularly, the digital wallet users satisfying a profile characteristic based on the historical transaction data of a plurality of payment card users.

In the following description, a payment card is a card that can be used by an account holder for a transaction with a merchant. In the following description, the term “payment cards” refer to any suitable transaction cards, such as credit cards, debit cards, prepaid cards, charge cards, membership cards, promotional cards, frequent flyer cards, identification cards, gift cards, and/or any other device that may hold payment account information, such as mobile phones, Smartphones, personal digital assistants (PDAs), key fobs, and/or computers. Each type of payment card can be used as a method of payment for performing a transaction.

In the following description, a digital wallet is an account that can be used by a digital wallet user for a transaction with a merchant. The digital wallet is usually linked to a digital wallet user's bank account or a digital wallet user's payment card. Typically, the payments by digital wallets are facilitated by a different entity, such as Google®, Apple®, or Paypal®. Such transactions that are made using the digital wallets are also known as wallet-based transactions.

In the following description, an account holder (or a customer) may refer to either a payment card user or a digital wallet user. In specific embodiments, the payment card user may also be a digital wallet user. For example, a payment card user may register his payment card to a digital wallet account which qualifies the payment card user as a digital wallet user. The account holder is a customer who initiates a transaction with a merchant. In one example, the customer may initiate the transaction with the merchant to buy goods and/or services from the merchant using his payment card. In another example, the customer may initiate the transaction with one merchant to buy goods and/or services from another merchant using his digital wallet. In an embodiment, the transaction is a payment transaction. In other words, completion of the transaction involves a payment between parties to the transaction.

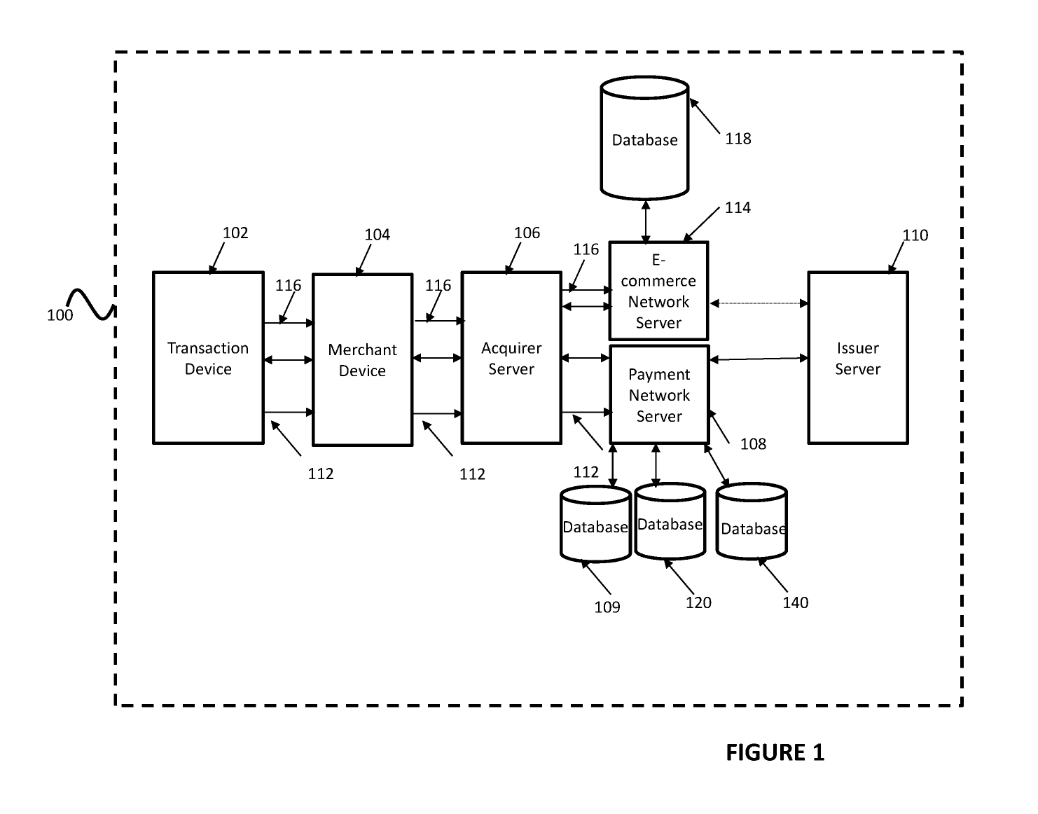

FIG. 1 illustrates a block diagram of a transaction system 100 within which transaction data can be received.

The system 100 includes a transaction device 102 in communication with a merchant device 104. The transaction device 102 may also be in direct communication with a payment network server 108, without having to communicate with the merchant device 104. In specific embodiments, the transaction device 102 may also be in direct communication with a wallet-based network server 114, without having to communicate with the merchant device 104.

The merchant device 104 is in communication with an acquirer server 106. The acquirer server 106, in turn, is in communication with the payment network server 108 and the wallet-based network server 114. The payment network server 108, in turn, is in communication with an issuer server 110. In specific embodiments, the acquirer server 106 may also be in communication with the wallet-based network server 114 which is in communication with the issuer server 110.

Use of the term ‘server’ herein can mean a single computing device or a plurality of interconnected computing devices which operate together to perform a particular function. That is, the server may be contained within a single hardware unit or be distributed among several or many different hardware units.

The transaction device 102 typically is associated with a customer who is a party to a transaction that occurs between the transaction device 102 and the merchant device 104 through a transaction. The transaction device 102 may be a fixed (wired) computing device or a wireless (portable) computing device. In specific implementations, the transaction device 102 may be a handheld or portable or mobile device carried or used by the customer, or may refer to other types of electronic devices, such as a personal computer, a land-line telephone or an interactive voice response (IVR) system, and the like. The mobile device may be a device, such as a mobile phone, a laptop computer, a personal digital assistant (PDA), a mobile computer, a portable music player (such as an iPod™ and the like).

The merchant device 104 typically is associated with the merchant who is also a party to the transaction that occurs between transaction device 102 and the merchant device 104 through the transaction. The merchant device 104 may be a point-of-sale (POS) terminal, an automatic teller machine (ATM), a personal computer, a computer server (hosting a website, for example), an IVR system, a land-line telephone, or any type of mobile device, such as a mobile phone, a personal digital assistant (PDA), a laptop computer, a tablet computer, and the like.

The acquirer server 106 generally is associated with an acquirer who may be an entity (e.g., a company or organization) which issues (e.g., establishes, manages, administers) a transaction credential or an account (e.g., a financial bank account) of the merchant. Examples of the acquirer include a bank and/or other financial institution. As stated in the above, the acquirer server 106 may include one or more computing devices that are used to establish communication with another server by exchanging messages with and/or passing information to the other server.

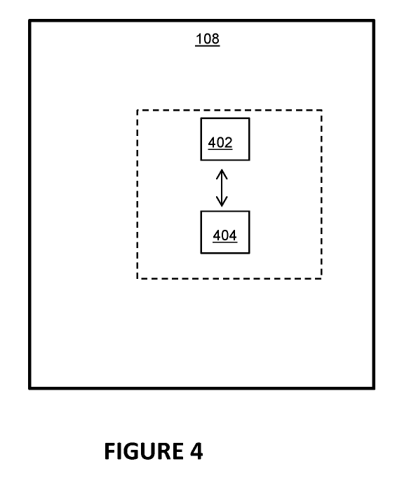

The payment network server 108 typically is associated with a payment facilitator. For example, the payment network server 108 may be the Banknet® network operated by MasterCard®. The payment facilitator (e.g., MasterCard®) may be an entity (e.g., a company or organization) who operates to process transactions, clear and settle funds for payments between two entities (e.g., two banks). The payment network server 108 may include one or more computing devices that are used for processing transactions. An exemplary payment network server 108 is shown in FIG. 4.

The wallet-based network server 114 typically is associated with a wallet-based facilitator. For example, the wallet-based network server 108 may be a server operated by Google®, Apple®, or Paypal®. The wallet-based facilitator (e.g., Google®, Apple®, or Paypal®) may be an entity (e.g., a company or organization) who operates to process wallet-based transactions, clear and settle funds for payments between two entities (e.g. two banks) in a wallet-based environment. The wallet-based network server 114 may include one or more computing devices that are used for processing transactions.

The issuer server 110 generally is associated with an issuer and may include one or more computing devices that are used to perform a payment transaction. The issuer may be an entity (e.g. a company or organization) which issues (e.g. establishes, manages, administers) a transaction credential or an account (e.g. a financial bank account). An account may be associated with a plurality of transaction devices 102.

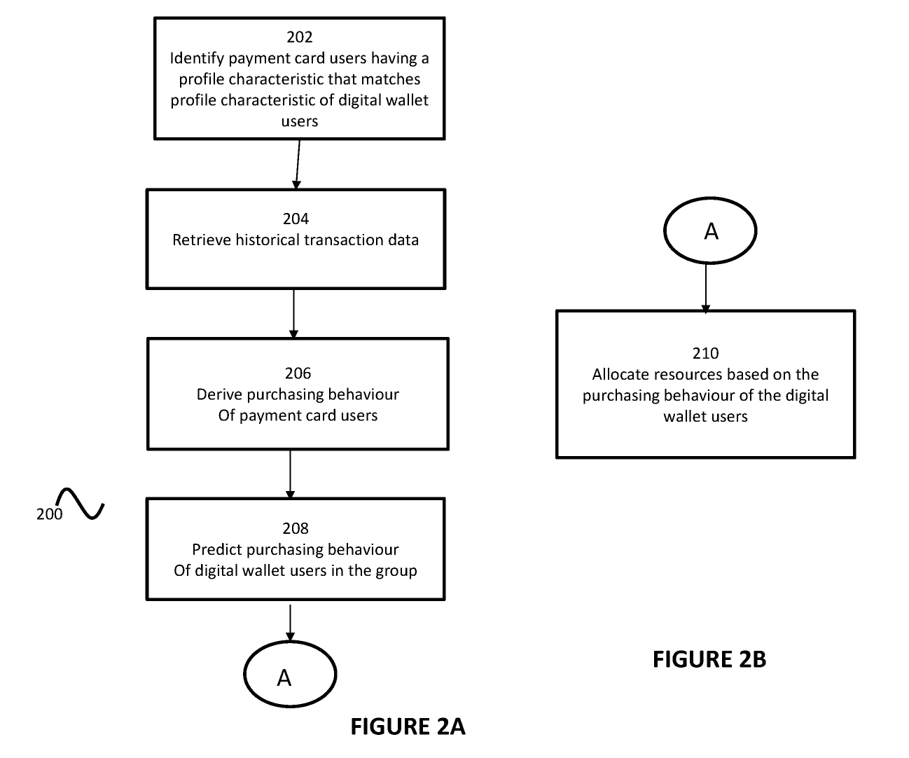

The payment network server 108 may be configured to communicate with, or may include, a database (or a transaction database) 109. The transaction database 109 stores data corresponding to a transaction (or transaction data). Examples of the data include Transaction ID, Merchant ID, Merchant Name, MCC/Industry Code, Industry Description, Merchant Country, Merchant Address, Merchant Postal Code, Aggregate Merchant ID. For example, data (“Merchant name” or “Merchant ID”) relating to the merchant, time and date for which the goods/services relating to the transaction will be delivered are included in the database 109. In other embodiments, the payment network server 108 may also be configured to communicate with, or may include, another database 140. The database 140 may include data corresponding to a payment card user. Examples of the data include name, age group, income group, address, gender, or the like relating to the payment card user. Further details on how these data are managed are described in FIG. 2 below.

In an embodiment, the payment network server 108 may be configured to communicate with, or may include, a third party database 120. The third party database 120 may store third party data associated with the payment card user. An example of a third party is a global information service company (e.g., Experian PLC). Examples of the third party data, includes but not limited to, profile information relating to the payment card users.

The transaction device 102 is capable of wireless communication using a suitable protocol with the merchant device 104. For example, embodiments may be implemented using transaction devices 102 that are capable of communicating with WiFi/Bluetooth-enabled merchant devices 104. It will be appreciated by a person skilled in the art that depending on the wireless communication protocol used, appropriate handshaking procedures may need to be carried out to establish communication between the transaction device 102 and the merchant device 104. For example, in the case of Bluetooth communication, discovery and pairing of the transaction device 102 and the merchant device 104 may be carried out to establish communication.

In an example, during a payment card transaction, a transaction request message 112 is generated at the transaction device 102. The transaction request message 112 is generated by the transaction device 102 in response to the customer (or payment card user) making a selection of a good and/or service to be purchased from the merchant. In other words, the transaction request message 112 relates to a transaction between the payment card user and the merchant. The transaction may be performed via a website of the merchant. In specific implementations, transaction device 102 may be fitted with a wireless communications interface, such as a Near Field Communication (NFC) interface to enable the transaction device 102 to electronically communicate with the merchant device 104 to perform the transaction. NFC is a set of standards to establish radio communication between devices by bringing them into close proximity, such as only a few centimetres. NFC standards cover communication protocols and data exchange formats, and are based on radio-frequency identification (RFID) technology.

The transaction request message 112 may include an indicator relating to the transaction device 102 and/or transaction data. Each transaction data relates to a transaction and identifies the payment card user and the merchant, generally by way of identifiers of each associated with the payment card user and merchant respectively. Further, the transaction data may also identify the good and/or service to be purchased and a type or nature of the transaction. The transaction data may further identify a value or price of the good and/or service (e.g., a transaction amount) and a location where the good and/or service will be delivered. The transaction data may also indicate a time and date at which the transaction was initiated by the payment card user.

The wallet-based network server 114 may be configured to communicate with, or may include, a database 118. The database 118 stores data corresponding to each digital wallet registered by the digital wallet user and data corresponding to a transaction. Examples of the data include data relating to the payment card used to register the digital wallet.

In another example, during a wallet-based transaction, a wallet-based transaction request message 116 is generated at the transaction device 102. The wallet-based transaction request message 116 is generated by the transaction device 102 in response to the customer (or digital wallet user) making a selection of a good and/or service to be purchased from the merchant. In other words, the wallet-based transaction request message 116 relates to a wallet-based transaction between the digital wallet user and the merchant. The transaction may be performed via a website of the merchant. Similar to the transaction request message 112, the wallet-based transaction message 116 may include an indicator relating to the transaction device and/or the transaction data.

The following types of transaction data may be included in the transaction request message 112 or the wallet-based transaction request message 116:

Transaction Level Information:
Transaction ID
Account ID (anonymized)
Merchant ID
Transaction Amount
Transaction Local Currency Amount
Date of Transaction
Time of Transaction
Type of Transaction
Date of Processing
Cardholder Present Code
Merchant Category Code (MCC)

Account (or Profile) Information:
Account ID (anonymized)
Card Group Code
Card Product Code
Card Product Description
Card Issuer Country
Card Issuer ID
Card Issuer Name
Aggregate Card Issuer ID
Aggregate Card Issuer Name

Merchant Information:
Merchant ID
Merchant Name
MCC/Industry Code
Industry Description
Merchant Country
Merchant Address
Merchant Postal Code
Aggregate Merchant ID
Aggregate Merchant Name
Merchant Acquirer Country
Merchant Acquirer ID

Issuer Information:
Issuer ID
Issuer Name
Aggregate Issuer ID
Issuer Country

The transaction request message 112 or the wallet-based transaction request message 116 is sent from the transaction device 102 to the merchant device 104. In a disclosed embodiment, for example, where the transaction is being performed at the website of the merchant, the transaction device 102 and the merchant device 104 are in communication with a network, such as the Internet (not shown for the sake of simplicity). In this example, the transaction request message 112 or the wallet-based transaction request message 116 is sent from the transaction device 102 to the merchant device 104 via the network.

As mentioned above, the role of the payment network server 108 or the wallet-based network server 114 is to facilitate communication between the acquirer server 106 and the issuer server 110. Therefore, the payment network server 108 or the wallet-based network server 114 may serve as a means through which the acquirer server 106 may communicate with the issuer server 110 in a manner that payments and authentication may be performed. In specific implementations, the payment network server 108 or the wallet-based network server 114 may receive transaction data when settling a transaction for a consumer and subsequently store/update the transaction data in the database 109 or the database 118, respectively.

The wallet-based network server 114 may be different and separate from the payment network server 108. In specific implementations, the payment network server 108 is further configured to perform additional operations. For example, the payment network server 108 may be configured to update the database 109 whenever a payment card user registers his payment card to a digital wallet account. Additionally, the payment network server 108 may also be configured to allocate resources for advertisements, redemptions, or promotions based on an analysis of the transaction data of a payment card user.

For example, if the analysis of the transaction data of the payment card user shows that the payment card user tends to purchase goods and/or services at a particular location, the payment network server 108 may be configured to allocate resources for promotions or advertisements relating to merchants in that particular location to the payment card user. However, this analysis is usually incomplete because the payment network server 108 is not configured to communicate with the database 118 which stores transaction data pertaining to wallet-based transactions (e.g., digital wallet transactions).

Similarly, if the analysis of the transaction data of the payment card user shows that the payment card user tends to purchase goods and/or services from merchants of a particular industry-type, the payment network server 108 may be configured to allocate resources for promotions or advertisements relating to merchants of that particular industry-type to the payment card users.

The transaction authorization process described above involves multiple parties (e.g., account holder, merchant, acquirer, issuer, payment facilitator). However, the transaction authorization process may be essentially viewed as a transaction between an account holder and a merchant (with the other parties facilitating the transaction).

FIG. 2 shows a flow chart 200 illustrating a computer-implemented method for predicting purchasing behaviour of digital wallet users for wallet-based transactions made by the digital wallet users, particularly, the digital wallet users satisfying a profile characteristic according to an example embodiment. The profile characteristic may refer to, among other things, an age group, a gender group, an income group, and a geographic group. The address included in the profile information gives an indication of a geographical location of the payment card users.

Referring to FIG. 2A, at step 202, payment card users who have a profile characteristic that matches the profile characteristic of the digital wallet user will be identified. This can be done by referring to the profile information of the payment card users that is registered with the corresponding payment card. In an implementation, the method is implemented to predict the purchasing behaviour of the digital wallet users for wallet-based transactions made by the digital wallet users who are in the age group of 25 years old to 30 years old. In this implementation, the profile characteristic is age group.

In order to do so, the payment network server 108 refers to a database that stores the profile characteristics of the payment card users so as to identify those who have the profile characteristic that matches the profile characteristic of the digital wallet users. The profile characteristics of the payment card users that are stored contains, among other information, the name, age group, income group, address, gender, or the like relating to the payment card users.

Based on the profile information, a plurality of payment card users having the profile characteristic that matches that of the digital wallet users can be identified. For example, a plurality of payment card users in the age group of 25 years old to 30 years old can be identified by referring to the corresponding age group indicated in each of the profile information. In another example, a plurality of payment card users in a specific income group, e.g., between $100,000 and $200,000, can be identified by referring to the corresponding income information indicated in each of the profile information. Each demographic group refers to, among other things, the age, gender, and income group of the payment card users in the group. In a further example, a plurality of payment card users living in a specific geographical location, e.g., California, U.S.A, can be identified by referring to the corresponding address information indicated in each of the profile information. This step may also be known as segmenting or classifying, and each demographic group may be referred as a “segment”.

In an embodiment, the profile information is matched with third party data associated with the payment card users. In an example, the identified profile information is compared and matched with Experian™ data in order to identify plurality of payment card users having the profile characteristic that matches that of the digital wallet users.

Once the payment card users are identified, a plurality of historical transaction data relating to a plurality of historical transactions settled for a plurality of payment card users is retrieved by the payment network server 108 by querying the transaction database 109. In the following description, “current transaction” refers to a transaction that is being settled, which is meant to be differentiated from “historical transactions” which relates to transactions that were already settled or initiated prior to the current transaction.

After step 204 is performed, step 206 may be performed. Step 206 involves identifying, from the retrieved historical transaction data, transaction information of the identified payment card users to derive purchasing behaviour of the identified plurality of payment card users. The transaction information includes, among other information, the transaction amount. The transaction amount gives an indication of how much the payment card users typically spend in each transaction category. Transaction categories can refer to an industry-type of a merchant or a location of a merchant. This helps to derive the purchasing behaviour of the payment card users.

As mentioned in the above, the transaction categories include, among other information, the identity of the merchant (e.g., Merchant ID and/or industry-type). As such, the merchants with whom the identified payment card users have made prior transactions can be identified based on the corresponding identities of the merchant in the historical transaction data. This makes it possible to further analyse the types of the merchants with whom the payment card users tend to initiate transactions. If necessary, various algorithms/rules will be applied to do the analysis.

Additionally or alternatively, the respective locations of the merchants can be obtained by referring to the transaction database 109 having stored thereon the location (e.g., postal address, latitude/longitude) of each merchant in association with the merchant ID. In this context, geographical location data of the merchant may include latitude and longitude coordinates, and a postal address. The latitude and longitude coordinates may be in any suitable format, such as: (i) Degrees, Minutes, and Seconds (DMS), (ii) Degrees and Decimal Minutes (DMM), and (iii) Decimal Degrees (DD). The purchasing behaviour of the payment card users can be identified based on the location of the merchants with whom they have prior transactions.

Typically, customers (payment card users and digital card users) in a specific group tend to have a similar spending habit or purchasing behaviour. That is, the purchasing behaviour of the payment card users for payment card transactions tends to be similar to the purchasing behaviour of the digital wallet users for wallet-based transactions. Based on this assumption, the purchasing behaviour of the digital wallet users for wallet-based transactions can be predicted in step 208 based on the purchasing behaviour of the payment card users.

Referring to FIG. 2B, step 210 may be performed after step 208 in an embodiment. Step 210 involves allocating resources based on the purchasing behaviour of the digital wallet users. For example, if the analysis of the transaction data of the payment card user shows that the digital wallet users are inclined to purchase goods and/or services at a particular location (e.g., a particular shopping mall), the payment network server 108 may be configured to allocate resources for promotions or advertisements relating to merchants in that particular location (e.g., a particular shopping mall) to the digital wallet users. That is, if the digital wallet users are detected to be at that particular shopping mall, the payment network server 108 may be configured to send promotion or advertisement materials to the digital wallet users.

In specific implementations, the historical transaction data of a plurality of payment card users are retrieved and analysed by the payment network server 108. In this way, an individual's particular spending habits are not scrutinised and the anonymity of the payment card users is maintained. Additionally, the payment network server 108 is configured to use factual and time-sensitive historical transaction data to create segments of one group of consumers (i.e., payment card users) to recognise purchasing behaviour of another group of consumers (i.e., digital wallet users).

As mentioned in the background, it is difficult or impossible to consolidate the historical transaction data of the digital wallet users. The predicted purchasing behaviour of the digital wallet users allows the payment network server 108 to accurately predict their future spending behaviour and hence, effectively allocates the resources.

In an implementation, the payment network server 108 is configured to allocate resources to promote or advertise merchants of a specific industry-type that the digital wallet users prefer. In another implementation, the payment network server 108 is configured to allocate resources to promote or advertise merchants in a specific location where the digital wallet users tend to prefer as described in step 210.

By the same token, the payment network server 108 may be configured to rank redemption offers in a manner that is consistent with the purchasing behaviour of the digital wallet users. For example, if it has been recognised that the digital wallet users spend the least transaction amount at merchants who sell apparel, the payment network server 108 may rank promotions relating to apparel higher than other promotions, so as to promote spending.

Additionally, the payment network server 108 may be configured to update the database 109 when settling a current transaction. This helps to keep the transaction data relevant and updated. The payment network server 108 may also be configured to update the database 109 when a consumer (e.g., a payment card user) registers or links a payment card to a digital wallet account.

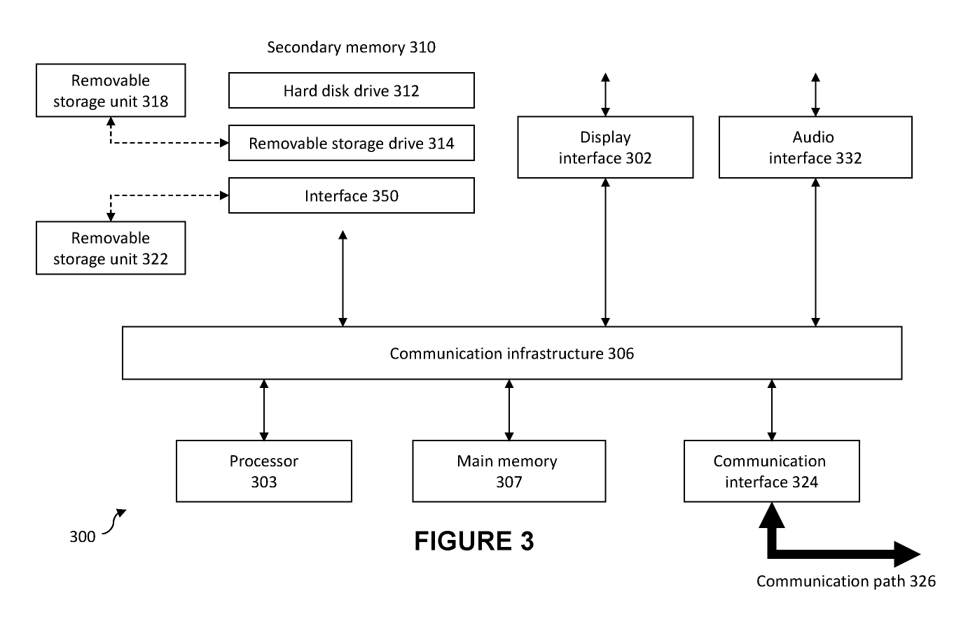

FIG. 3 depicts an exemplary computer/computing device 300, hereinafter interchangeably referred to as a computer system 300, where one or more such computing devices 300 may be used to facilitate execution of the above-described method for providing a travel recommendation to a user. In addition, one or more components of the computer system 300 may be used to realize the computer 302. The following description of the computing device 300 is provided by way of example only and is not intended to be limiting.

As shown in FIG. 3, the example computing device 300 includes a processor 304 for executing software routines. Although a single processor is shown for the sake of clarity, the computing device 300 may also include a multi-processor system. The processor 304 is connected to a communication infrastructure 306 for communication with other components of the computing device 400. The communication infrastructure 306 may include, for example, a communications bus, cross-bar, or network.

The computing device 300 further includes a main memory 308, such as a random access memory (RAM), and a secondary memory 310. The secondary memory 310 may include, for example, a storage drive 312, which may be a hard disk drive, a solid state drive or a hybrid drive, and/or a removable storage drive 314, which may include a magnetic tape drive, an optical disk drive, a solid state storage drive (such as a USB flash drive, a flash memory device, a solid state drive or a memory card), or the like. The removable storage drive 314 reads from and/or writes to a removable storage medium 344 in a well-known manner. The removable storage medium 344 may include magnetic tape, optical disk, non-volatile memory storage medium, or the like, which is read by and written to by removable storage drive 314. As will be appreciated by persons skilled in the relevant art(s), the removable storage medium 344 includes a computer readable storage medium having stored therein computer executable program code instructions and/or data.

In an alternative implementation, the secondary memory 310 may additionally or alternatively include other similar means for allowing computer programs or other instructions to be loaded into the computing device 300. Such means can include, for example, a removable storage unit 322 and an interface 340. Examples of a removable storage unit 322 and interface 340 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 322 and interfaces 340, which allow software and data to be transferred from the removable storage unit 322 to the computer system 300.

The computing device 300 also includes at least one communication interface 324. The communication interface 324 allows software and data to be transferred between computing device 300 and external devices via a communication path 326. In various embodiments of the disclosure, the communication interface 324 permits data to be transferred between the computing device 300 and a data communication network, such as a public data or private data communication network. The communication interface 324 may be used to exchange data between different computing devices 300, wherein such computing devices 300 form part an interconnected computer network. Examples of a communication interface 324 can include a modem, a network interface (such as an Ethernet card), a communication port (such as a serial, parallel, printer, GPIB, IEEE 1394, RJ25, USB), an antenna with associated circuitry and the like. The communication interface 324 may be wired or may be wireless. Software and data transferred via the communication interface 324 are in the form of signals which can be electronic, electromagnetic, optical, or other signals capable of being received by communication interface 324. These signals are provided to the communication interface via the communication path 326.

As shown in FIG. 3, the computing device 300 further includes a display interface 302 which performs operations for rendering images to an associated display 330 and an audio interface 332 for performing operations for playing audio content via associated speaker(s) 334.

As used herein, the term “computer program product” may refer, in part, to removable storage medium 344, removable storage unit 322, a hard disk installed in storage drive 312, or a carrier wave carrying software over communication path 326 (wireless link or cable) to communication interface 324. Computer readable storage media refers to any non-transitory, non-volatile tangible storage medium that provides recorded instructions and/or data to the computing device 300 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card, such as a SD card and the like, whether or not such devices are internal or external of the computing device 300. Examples of transitory or non-tangible computer readable transmission media that may also participate in the provision of software, application programs, instructions and/or data to the computing device 300 include radio or infra-red transmission channels as well as a network connection to another computer or networked device, and the Internet or Intranets including e-mail transmissions and information recorded on Websites and the like.

The computer programs (also called computer program code) are stored in main memory 308 and/or secondary memory 310. Computer programs can also be received via the communication interface 324. Such computer programs, when executed, enable the computing device 300 to perform one or more features of embodiments discussed herein. In various embodiments, the computer programs, when executed, enable the processor 304 to perform features of the above-described embodiments. Accordingly, such computer programs represent controllers of the computer system 300.

Software may be stored in a computer program product and loaded into the computing device 400 using the removable storage drive 314, the storage drive 312, or the interface 340. Alternatively, the computer program product may be downloaded to the computer system 300 over the communications path 326. The software, when executed by the processor 304, causes the computing device 300 to perform functions of embodiments described herein.

It is to be understood that the embodiment of FIG. 3 is presented merely by way of example. Therefore, in some embodiments one or more features of the computing device 300 may be omitted. Also, in some embodiments, one or more features of the computing device 300 may be combined together. Additionally, in some embodiments, one or more features of the computing device 300 may be split into one or more component parts.

In an implementation, the payment network server 108 may be generally described as a physical device including at least one processor 402 and at least one memory 404 including computer program code. The at least one memory 404 and the computer program code are configured to, with the at least one processor 402, cause the physical device to perform the operations described in FIG. 2. In an implementation, the payment network server 108 may also be configured to perform the operations of the wallet-based network server 114 described in FIG. 1. An example of the payment network server 108 is shown in FIG. 4.

For example, the method of FIG. 2 may be implemented as software and stored in a non-transitory fashion in the secondary memory 310 or in the removable storage units 318, 322 of the computer device 300.

It will be appreciated by a person skilled in the art that numerous variations and/or modifications may be made to the present disclosure as shown in the specific embodiments without departing from the spirit or scope of the disclosure as broadly described. For example, the above description mainly discusses the use of a Bluetooth connection, but it will be appreciated that another type of secure wireless connection, such as Wi-Fi, can be used in alternate embodiments to implement the method. Some modifications, e.g., adding an access point, changing the log-in routine, etc. may be considered and incorporated. The present embodiments are, therefore, to be considered in all respects to be illustrative and not restrictive.

1. A computer-implemented method for predicting purchasing behaviour of digital wallet users for wallet-based transactions made by the digital wallet users, the digital wallet users satisfying a profile characteristic, the method comprising:
identifying payment card users having a profile characteristic that matches the profile characteristic of the digital wallet users;
retrieving historical transaction data by querying a transaction database, the historical transaction data relating to a plurality of historical transactions settled for the identified payment card users;
identifying, from the retrieved historical transaction data, transaction information of the identified payment card users to derive purchasing behaviour of the identified payment card users; and
predicting the purchasing behaviour of the digital wallet users for wallet-based transactions made by the digital wallet users, based on the derived purchasing behaviour of the identified payment card users.

2. The method according to claim 1, wherein the step of predicting purchasing behaviour of the digital wallet users further comprises:
identifying a plurality of transaction amounts by querying the transaction database having stored thereon the transaction amounts corresponding to the plurality of historical transaction data, each of the corresponding transaction amount relating to an amount that the identified payment card users have spent in each of a plurality of transaction categories; and
identifying a corresponding transaction amount that the digital wallet users have spent in each of the plurality of transaction categories based on the identified corresponding transaction amount of the identified payment card users.

3. The method according to claim 2, wherein the transaction categories includes an industry-type of a merchant and a location of the merchant, the merchant being one with whom one of the identified payment card users has initiated a transaction.

4. The method according to claim 1, further comprising:
updating the database when settling a current transaction initiated by one of the identified payment card users.

5. The method according to claim 1, further comprising allocating resources based on the predicted purchasing behaviour of the digital wallet users.

6. The method according to claim 1, wherein the identified payment card users include at least one digital wallet user.

7. The method according to claim 6, further comprising updating the database when registering a payment card to a digital wallet account.

8. The method according to claim 1, wherein the profile characteristic includes at least one of an age group, a gender group, an income group, and a geographic group.

9. The method according to claim 1, wherein the step of identifying payment card users includes matching the profile information of the digital wallet users with third party data by referring to a third party database having thereon the third party data.

10. An apparatus for predicting purchasing behaviour of digital wallet users for wallet-based transactions made by the digital wallet users, the digital wallet users satisfying a profile characteristic, the apparatus comprising:
at least one processor; and
at least one memory including computer program code;
the at least one memory and the computer program code, with at least one processor, configured to:
identify payment card users having a profile characteristic that matches the profile characteristic of the digital wallet users;
retrieve historical transaction data by querying a transaction database, the historical transaction data relating to a plurality of historical transactions settled for payment card users;
identify, from the retrieved historical transaction data, transaction information of the identified payment card users to derive purchasing behaviour of the identified payment card users; and
predict the purchasing behaviour of the digital wallet users for the wallet-based transactions made by the digital wallet users, based on the derived purchasing behaviour of the identified plurality of payment card users.

11. The apparatus according to claim 10, wherein the at least one memory and the computer program code, with the at least one processor, is further configured to:
identify a plurality of transaction amounts by querying the transaction database having stored thereon the transaction amounts corresponding to the plurality of historical transaction data, each of the corresponding transaction amount relating to an amount that the identified payment card users have spent in each of a plurality of transaction categories; and
identify a corresponding transaction amount that the digital wallet users have spent in each of the plurality of transaction categories based on the identified corresponding transaction amount of the identified payment card users.

12. The apparatus according to claim 11, wherein the transaction categories includes an industry-type of a merchant and a location of the merchant, the merchant being one with whom the identified payment card users has initiated a transaction.

13. The apparatus according claim 10, wherein the at least one memory and the computer program code is further configured with the at least one processor to:
update the database when settling a current transaction initiated by one of the identified payment card users.

14. The apparatus according to claim 10, wherein the at least one memory and the computer program code is further configured with the at least one processor to:
allocate resources based on the predicted purchasing behaviour of the digital wallet users.

15. The apparatus according to claim 10, wherein the identified payment card users include at least one digital wallet user.

16. The apparatus according to any one of claims 15, wherein the at least one memory and the computer program code, with the at least one processor, is further configured to:
update the database when registering a payment card to a digital wallet account.

17. The apparatus according to claim 10, wherein the profile characteristic includes at least one of an age group, a gender group, an income group and a geographic group.

18. The apparatus according to claim 10, wherein the at least one memory and the computer program code, with the at least one processor, is further configured to:
match the profile characteristic of the digital wallet users with third party data by referring to a third party database having thereon the third party data.

19. A computer-readable storage medium having stored thereon computer program code which when executed by a computer causes the computer to execute a method comprising:
identifying payment card users having a profile characteristic that matches the profile characteristic of the digital wallet users;
retrieving historical transaction data by querying a transaction database, the historical transaction data relating to a plurality of historical transactions settled for the identified payment card users;
identifying, from the retrieved historical transaction data, transaction information of the identified payment card users to derive purchasing behaviour of the identified payment card users; and
predicting the purchasing behaviour of the digital wallet users for wallet-based transactions made by the digital wallet users, based on the derived purchasing behaviour of the identified payment card users.
